(19) United States
(12) Patent Application Publication
(10) Pub. No.: US 2006/0230163 A1
(43) Pub. Date: Oct. 12, 2006

(54) System and method for securely establishing a direct connection between two firewalled computers

(76) Inventor: Russell H. Fish III, Dallas, TX (US)

Correspondence Address: MORGAN LEWIS & BOCKIUS LLP, 1111 PENNSYLVANIA AVENUE NW, WASHINGTON, DC, 20004, US

(21) Appl. No.: 11/386,173

(22) Filed: Mar. 22, 2006

Related U.S. Application Data
(60) Provisional application No. 60/664,508, filed on Mar. 23, 2005.

(51) Int. Cl. G06F 15/16

(52) U.S. Cl. 709/229

(57) ABSTRACT

The disclosed system describes a means for internetworked computers protected behind blocking firewalls to communicate directly with other internetworked computers protected behind blocking firewalls. A trusted computer helps establish a connection between the two protected computers, but all subsequent communications takes place directly between the two protected computers.

### CROSS-REFERENCE TO RELATED APPLICATIONS

This application claims the benefit of U.S. Provisional Application No. 60/664,508, filed Mar. 23, 2005. The entire contents of that provisional application are incorporated herein by reference.

### BACKGROUND

The original Internet creators envisioned all connected computers being able to communicate directly. The adoption of firewall routers and Network Address Translation (NAT) routers has made the original vision very difficult to achieve. Firewall routers limit or prevent inbound connections. NAT routers make a computer's network address variable and difficult to determine.

TCP is the reliable transport protocol used by most of the Internet. TCP establishes a network connection by use of a three way handshake. Data is sent in packets that are acknowledged when received and resent if they are not received.

For security reasons, most computers are connected to the Internet behind a firewall. A direct Internet connection can allow a malicious program to trick a computer into allowing unauthorized access. Firewalls allow an internetworked computer to browse Internet Web pages but restrict inbound connections.

Sophisticated firewalls inspect Internet traffic to allow only traffic that corresponds to outbound Web page requests and the corresponding responses. In the most restrictive firewalls all other network traffic is blocked.

A firewall often will include Network Address Translation (NAT) capability. NAT allows hundreds of computers behind a firewall to share the same Internet address distinguished by a port.

FIGS. 1 through 6 depict the existing state of the art of TCP communications of internetworked computers in the presence of firewalls and NAT routers.

FIG. 1 depicts the TCP three-way connection handshake. The purpose of the handshake is to guarantee that both sides of any connection are aware that the other side is connected.

FIG. 2 depicts the sending and acknowledgement of data across a TCP connection. Each packet sent is acknowledged as received. If no acknowledgement is received within a certain amount of time, the sender assumes the packet was lost, and the packet is resent.

FIG. 3 depicts the simplest of internetworked computer connections. Computer 310 has an IP address and is connected to the Internet 320 and identified to the network by that IP address. The IP address is constant and Computer 310 knows its own IP address and that IP address is the same one used by other computers connected to the Internet 320 to connect to the Computer 310. All ports associated with the Computer 310 are unchanged and accessible to other computers connected to the Internet 320.

FIG. 4 depicts an internetworked computer protected by a Firewall 430. The Computer 310 has an IP address and is connected to the Internet 320 through a Firewall 430 and identified to the network by that IP address. The IP address is constant and Computer 310 knows its own IP address and that IP address is the same one used by other computers connected to the Internet 320 to connect to the Computer 310. However, inbound connections originated by other computers connected to the Internet 320 are restricted. In the most severe case, the Firewall 430 blocks all inbound connections to the Computer 310. In a less restrictive case, the Firewall 430 will block inbound connections to specific ports on the Computer 310.

FIG. 5 depicts an internetworked computer protected by a Network Address Translation (NAT) Router 540. The Computer 310 has an IP address and is connected to the Internet 320 through a NAT Router 540 and identified to the network by a combination of the NAT Router's 4 IP address and a port created by the NAT Router 540. The Computer 310 knows its own IP address and the ports on which it is listening, but that IP address is different from the IP address and ports visible to the Internet 320. Inbound connections are very difficult to make because the ports and IP addresses of the Computer 310 are translated and made visible to the Internet 320. Furthermore, the translated ports visible to the Internet 320 may not remain constant even though the ports and IP addresses associated with specific application on the Computer 310 are constant.

FIG. 6 depicts an internetworked computer protected by both a Firewall 430 and a NAT Router 540. The Computer 310 has an IP address and is connected to the Internet 320 through both a NAT Router 540 and a Firewall 430 and identified to the network by a combination of the NAT Router 540's IP address and a port created by the NAT Router 540. Computer 310 knows its own IP address and the port on which it is listening, but that IP address is different from the IP address and port visible to the Internet 320. Furthermore, inbound connections are blocked by the Firewall 430. A combined Firewall 430 and NAT Router 540 configuration is the most difficult protection to traverse.

Most communications applications involve an originator and a destination. For example, someone originates a phone call and someone else answers at the destination. Many applications in the computer world work similarly. These applications include VoIP, videophone, games, instant messaging, and many types of groupware.

Firewalls and NAT routers greatly limit the usability of these applications.

Computers behind firewalls or NAT routers can originate outbound connections and receive information back from Web sites. Two computers behind different firewalls make outbound connections to a third computer that is not behind a firewall. The third computer can pass information from one firewalled machine to the other. The third computer is often called a “proxy.”

The disadvantage of a proxy solution is that all information between the two originating computers must also pass through the proxy. For applications such as VoIP or video, the bandwidth requirements of numerous proxied connections scale linearly with the number of proxied connections. A single 100 Kbit/sec video connection requires 100 Kbit/sec of proxy bandwidth coming and going. One hundred connections require 100*100K*2 or 20 Mbit/sec of proxy bandwidth.

Furthermore, if the proxy is located in a low cost foreign country, an unacceptable delay of several seconds will be added to all communications between the participating computers.

Several practitioners have observed that setting TCP packets to low time to live (TTL) values allows the testing of firewall performance. TTL in this context defines the duration in seconds that a record may be cached. A TTL of zero indicates the record should not be cached. These practitioners include Andrea Barisani of the University of Trieste, Lance Spitzer, and Siddhartha Jain of Bank Muscat.

### SUMMARY

A preferred embodiment of the present invention uses a trusted third computer to set up direct communications between two firewalled or NAT'd computers running the embodiment's network drivers. Network traffic appears as outbound traffic to the internetworked computer's firewalls. Following the connection setup, direct communications between the two firewalled or NAT'd computers functions in a manner almost identical to traditional TCP communications.

The benefits are that communications traffic flows directly between the originating computer and destination computer without the expense of proxy bandwidth or proxy computer processing power. In addition, the connections proceed with the same network delay that would exist in a traditional TCP direct connection.

In a preferred embodiment, the invention creates network traffic that is consistent with the TCP specification by requiring all computers to first make an outbound TCP connection to a non-firewalled computer. Firewalled computers using the invention randomly assign source ports to the outbound TCP connection packets, consistent with the TCP specification. When two firewalled computers are directly connected using the invention, the source port of one firewalled computer becomes the destination port of the other computer, consistent with the TCP specification. Thus, both source and destination port numbers preferably are random for all direct connection communications between firewalled computers using the invention. As a result, the traffic profiling by port analysis used by some networks to restrict the availability of some Internet features for some users is likely to be substantially reduced.

The system is secure since all connections require setup by a trusted third computer. All connections are logged. In addition, connections from and to particular originators or destinations may be restricted similar to that possible with firewall rules.

One embodiment of the present invention is directed to a method for connecting a first computer protected by a first firewall to a second computer protected by a second firewall using a trusted computer, the method comprising: registering the first computer with the trusted computer; receiving a connection request from the trusted computer, the connection request including an IP address and port number of the second computer; opening a plurality of ports through the first firewall; receiving an acknowledgement from the trusted computer on a penetration port, the penetration port being one of the plurality of opened ports; sending the trusted computer the port number of the penetration port; and receiving data directly from the second computer on the penetration port. In some embodiments, the first firewall is configured to block inbound connections to a port on the first computer. In some embodiments, the first firewall is configured to block all inbound connections to the first computer. A further aspect of the step of registering further comprises sending the trusted computer an IP address and port number of the first computer. A further aspect of opening further comprises receiving a guessed port number of the second computer from the trusted computer; sending a plurality of messages to the second computer's IP address and guessed port, each of the plurality of messages opening a port on the first computer. Another aspect includes sending a “blizzard sent” message to the trusted computer. In a further aspect, each of the plurality of messages has a short TTL. In some embodiments, the acknowledgement from the trusted computer is modified to indicate the second computer's IP address and guessed port as the origin of the acknowledgement.

Another embodiment of the present invention is directed to a method for assisting a first computer protected by a first firewall to connect to a second computer protected by a second firewall, the method comprising: receiving from the first computer a request to connect to the second computer; sending a connection request to the second computer; maintaining a hole through the second firewall created by the second computer; receiving a destination port number from the second computer, the receiving port number corresponding to the punched hole in the second firewall; maintaining a hole through the first firewall created by the first computer; receiving a origination port number from the first computer, the origination port number corresponding to the punched hole in the first firewall; sending a message to the second computer confirming a direct connection between the first and second computers. In some embodiments, the second firewall is configured to block inbound connections to a port on the second computer. In some embodiments, the second firewall is configured to block all inbound connections to the second computer. In some embodiments, the first firewall is configured to block inbound connections to a port on the first computer. In some embodiments, the connection request sent to the second computer comprises an IP address of the first computer. In a further aspect, the step of maintaining a hole through the second firewall further comprises: instructing the second computer to open a plurality of ports through the second firewall, the plurality of ports based, in part, on a guessed port number; receiving from the second computer a message indicating that the plurality of ports through the second firewall have been opened; and sending a plurality of messages to the second computer, each of the plurality of messages having a different port number, the different port number based, in part, on the guessed port number. In a further aspect, the step of maintaining a hole through the first firewall further comprises: instructing the first computer to open a plurality of ports through the first firewall; receiving from the first computer a message indicating that the plurality of ports through the first firewall have been opened; and sending a plurality of messages to the first computer, each of the plurality of messages having a different port number. In a further aspect, each of the plurality of messages sent to the second computer is modified to indicate the originator of the messages is the first computer. In a further aspect, each of the plurality of messages sent to the first computer is modified to indicate the originator of the messages is the second computer.

Another embodiment of the present invention is directed to a computer-readable medium having computer-executable instructions for performing a method for assisting a first computer protected by a first firewall to connect to a second computer protected by a second firewall, the method comprising: receiving from the first computer a request to connect to the second computer; sending a connection request to the second computer; maintaining a hole through the second firewall created by the second computer; receiving a destination port number from the second computer, the receiving port number corresponding to the punched hole in the second firewall; maintaining a hole through the first firewall created by the first computer; receiving a origination port number from the first computer, the origination port number corresponding to the punched hole in the first firewall; sending a message to the second computer confirming a direct connection between the first and second computers.

### BRIEF DESCRIPTION OF THE DRAWINGS

FIG. 1 depicts a TCP protocol connection setup.

FIG. 2 depicts a TCP protocol data acknowledgement.

FIG. 3 depicts an internetworked computer connected directly to the Internet.

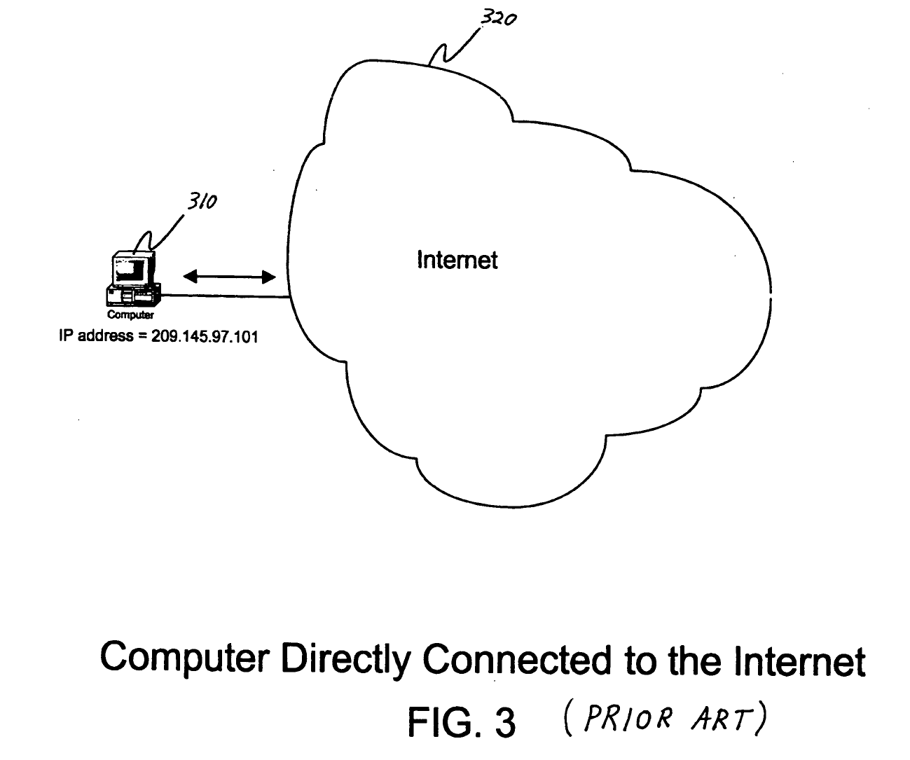

FIG. 4 depicts an internetworked computer connected to the Internet behind a Firewall.

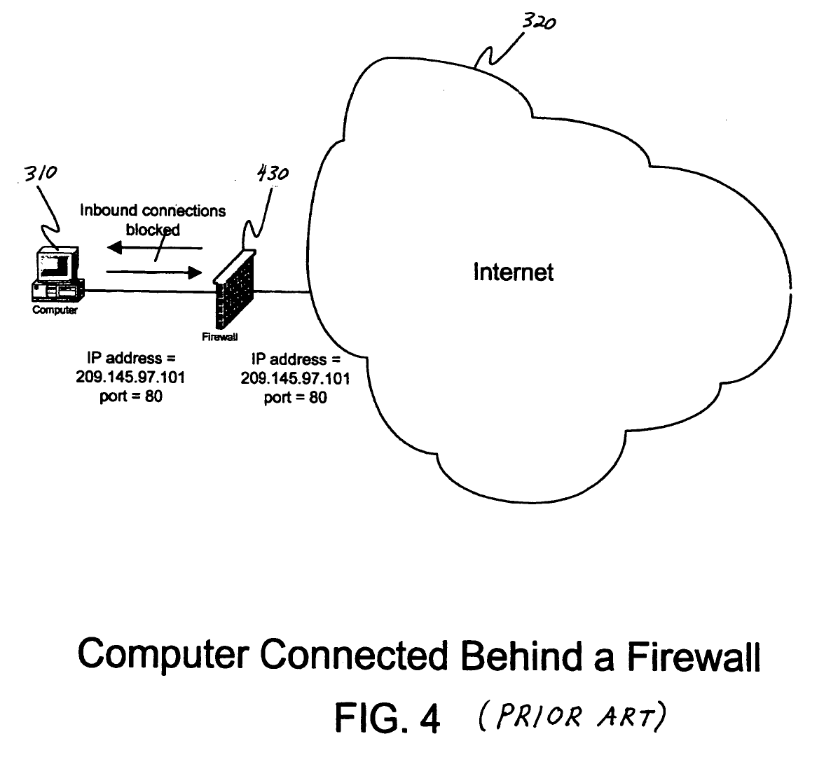

FIG. 5 depicts an internetworked computer connected to the Internet behind a NAT router.

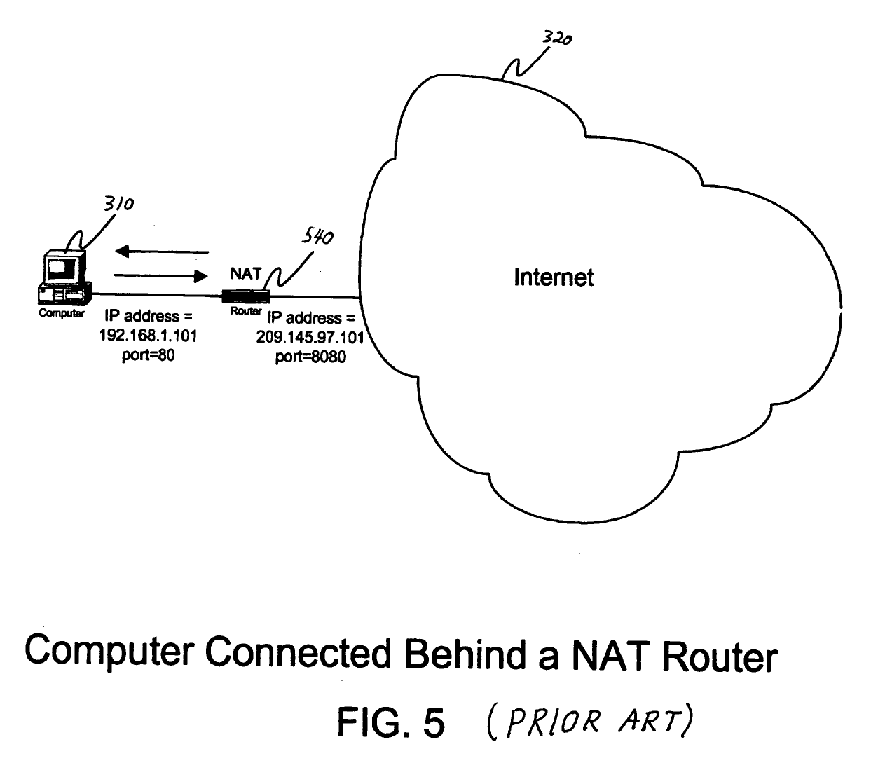

FIG. 6 depicts an internetworked computer connected to the Internet behind both a Firewall and a NAT Router.

FIG. 7 depicts a state machine of an embodiment of the invention for the Firewalled Computers.

FIG. 8 depicts a state machine of an embodiment of the present invention for the Non-firewalled Computer.

FIG. 9 depicts a protocol connection setup in an embodiment of the present invention.

FIG. 10 depicts a protocol data acknowledgement in an embodiment of the present invention.

FIG. 11 depicts an internetwork consisting of a Sender Computer, a Sender Firewall, a Receiver Computer, a Receiver Firewall, and a Non-firewalled Computer.

### DETAILED DESCRIPTION

A preferred embodiment may be instantiated as a software driver that has a similar programming interface to existing software drivers such as those for TCP (Transmission Control Protocol).

The software drivers may therefore be easily linked to existing programs and provide existing applications with firewall traversal.

Firewalls work by inspecting each packet that comes in or goes out on the internetwork and deciding if that packet corresponds to an allowed state of an allowed connection. For example, the first packet of a TCP connection must be a SYN. If the firewall is configured to block all incoming connections, all inbound SYN packets would be blocked and a RESET sent to the sender. A “fully blocking firewall” will prevent all inbound connections.

In a preferred embodiment, packet traffic that corresponds to traffic the firewall has authorized to pass is created. In this manner, a firewalled computer may directly connect to another firewalled computer that has previously made its presence known to a non-firewalled computer.

For purposes of illustration, the system described may include one or more of the following assumptions. These assumptions are not intended to be limiting but are made to provide a basis for the description below. First, a fully blocking firewall allows outbound TCP connections. An example would be a Web page request. Second, two computers behind blocking firewalls may make outbound TCP connections to a non-firewalled third party computer, and that third party computer may pass data between the two computers behind blocking firewalls. Third, a fully blocking firewall will allow inbound packets that correspond to an existing outbound connection. An example would be packets returning from a Web page request. Fourth, all packets have a “Time to Live” (TTL) parameter that determines how many router hops a packet will travel toward its destination before it stops and returns. Fifth, a non-firewalled computer may send packets to a firewalled computer containing another computer's IP address as the source.

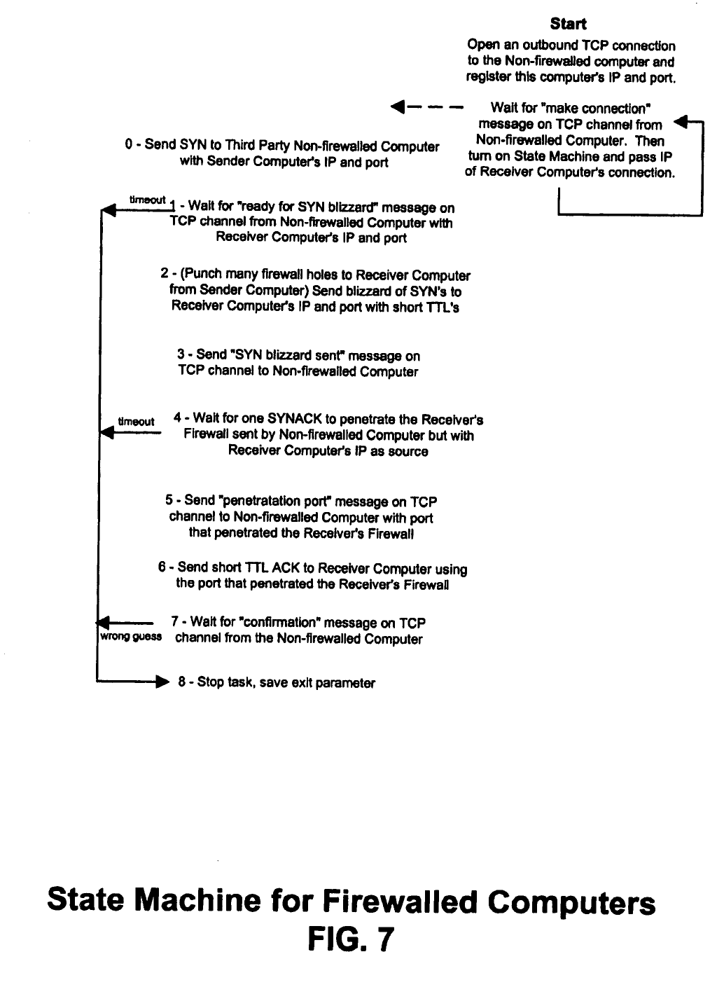

FIGS. 7 through 10 depict a preferred process for establishing a direct connection between two firewalled computers used in some embodiments of the present invention.

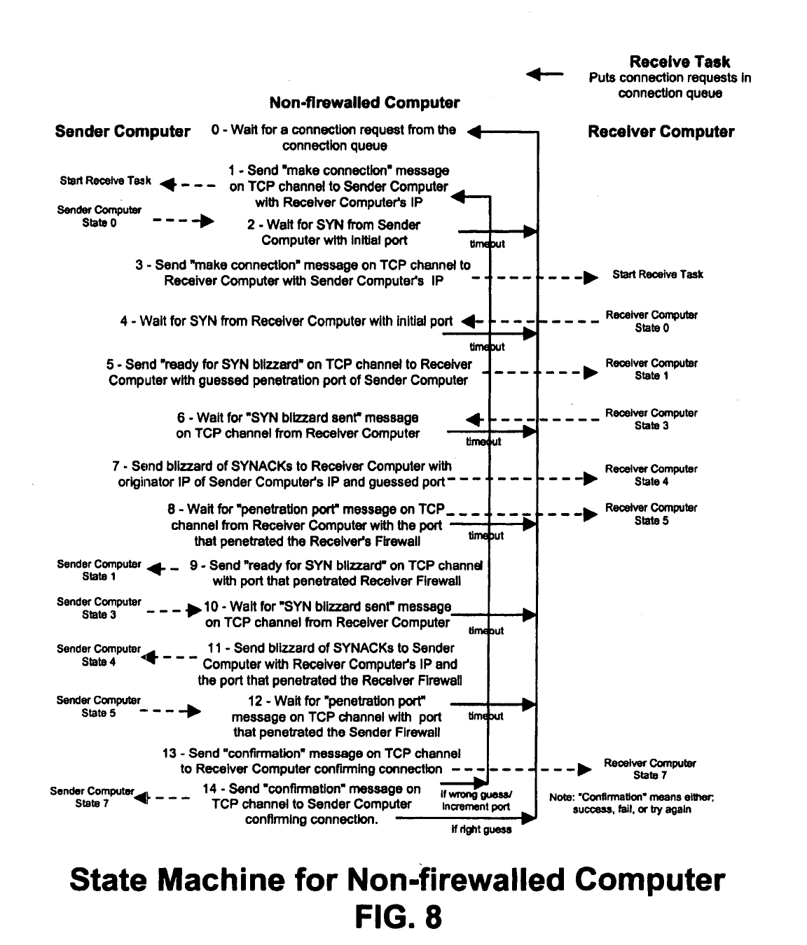

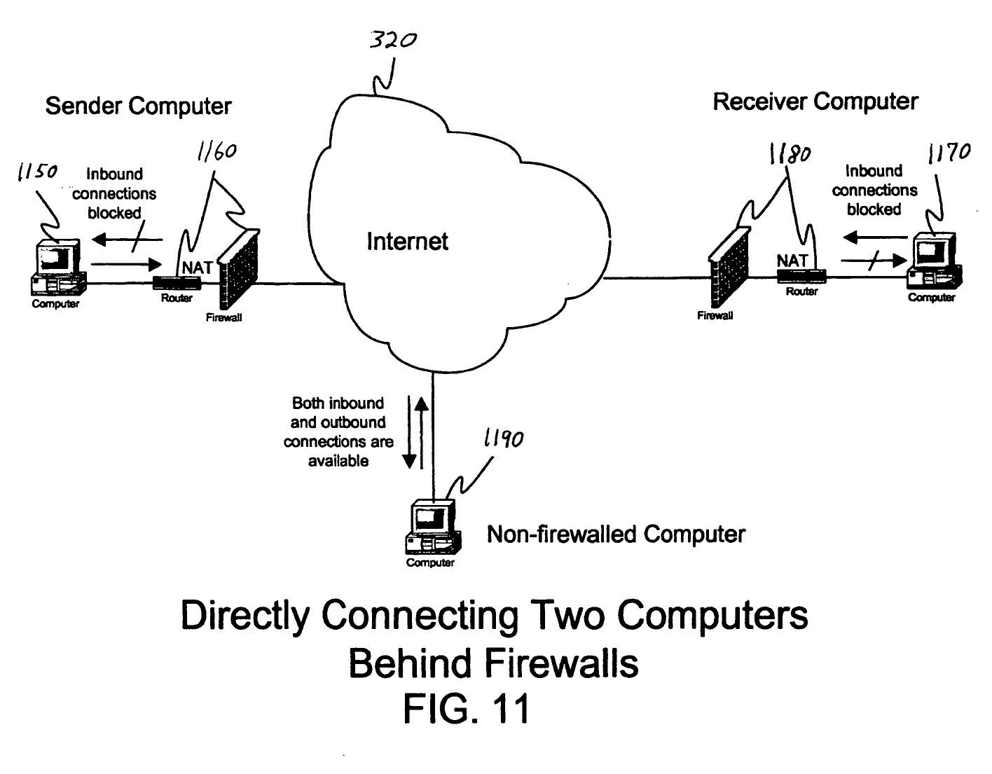

FIG. 7 depicts a state machine of the Firewalled Computers 1150 and 1170 (see FIG. 11). The state machines are identical for the Sender Computer 1150 and Receiver Computer 1170. When a potential Sender Computer 1150 or Receiver Computer 1170 starts up, it opens an outbound TCP connection to the Non-firewalled Computer 1190 (see FIG. 11) and listens for messages returned on the TCP connection from the Non-firewalled Computer 1190. FIG. 8 depicts the state machine of the Non-firewalled Computer 1190.

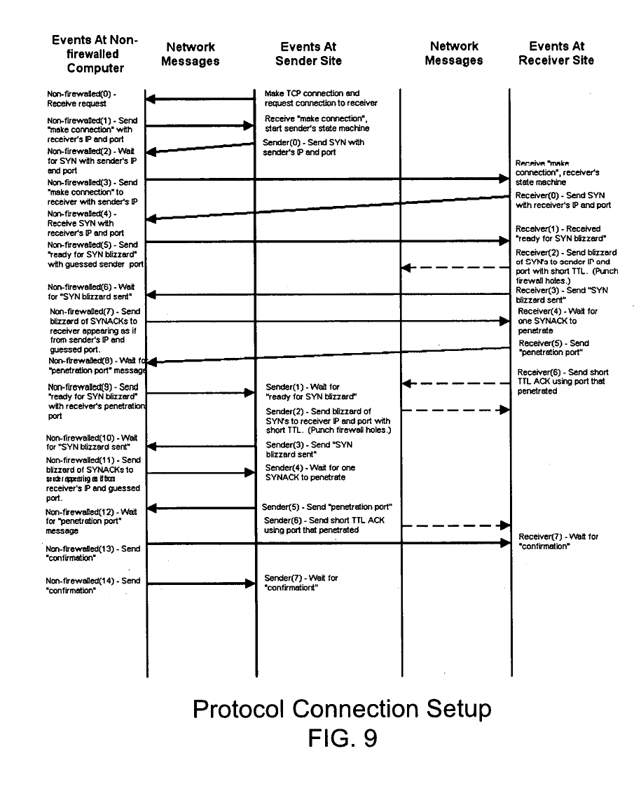

The operation of the state machines may be most easily understood by observing the network traffic depicted in FIG. 9 between the Sender Computer 1150, the Receiver Computer 1170, and the Non-firewalled Computer 1190. The corresponding sender states, receiver states, and non-firewalled states are indicated along with each event in FIG. 9.

Protocol Profiling Mitigation: Some Internet Service Providers reduce their bandwidth requirements by throttling packets associated with particular TCP ports. This selective bandwidth reduction depends on the detection of static ports associated with particular services. The invention preferably randomizes both its source and destination ports in its TCP packets, thereby mitigating protocol profiling performed by source or destination port detection.

As shown in FIG. 9, Events At Sender Site, the first event shown is “Make TCP connection and request connection to receiver.” Both the source and destination ports in this initial TCP connection to an IP address on the Nonfirewalled Computer 1190 may be randomized. All TCP packets sent the Nonfirewalled Computer 1190's IP address, regardless of destination port, are directed to the Nonfirewalled Computer 1190's state machine as shown in FIG. 9, Events At Nonfirewalled Computer.

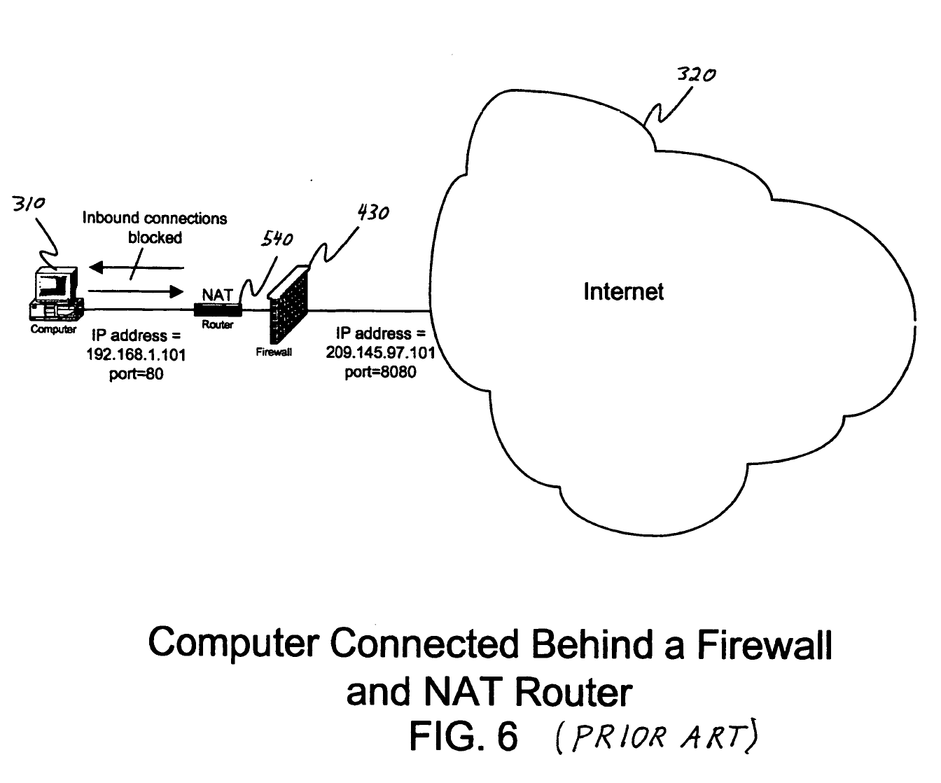

As shown in FIG. 9, Events At Sender Site, a third event shown is “Sender(0)-Send SYN with sender's IP and port.” The invention preferably uses a randomly chosen source port for this SYN. When the SYN passes through a firewall or NAT as shown in FIG. 6, the initial source port is likely to be further randomized and rewritten in the SYN packet.

The Nonfirewalled Computer 1190 records the random source port received from the Sender. The received source port is used as the destination port for any subsequent incoming connection to the firewalled Sender Computer 1150. As a result, both source and destination ports of all communications both behind and in front of a firewall or NAT are random.

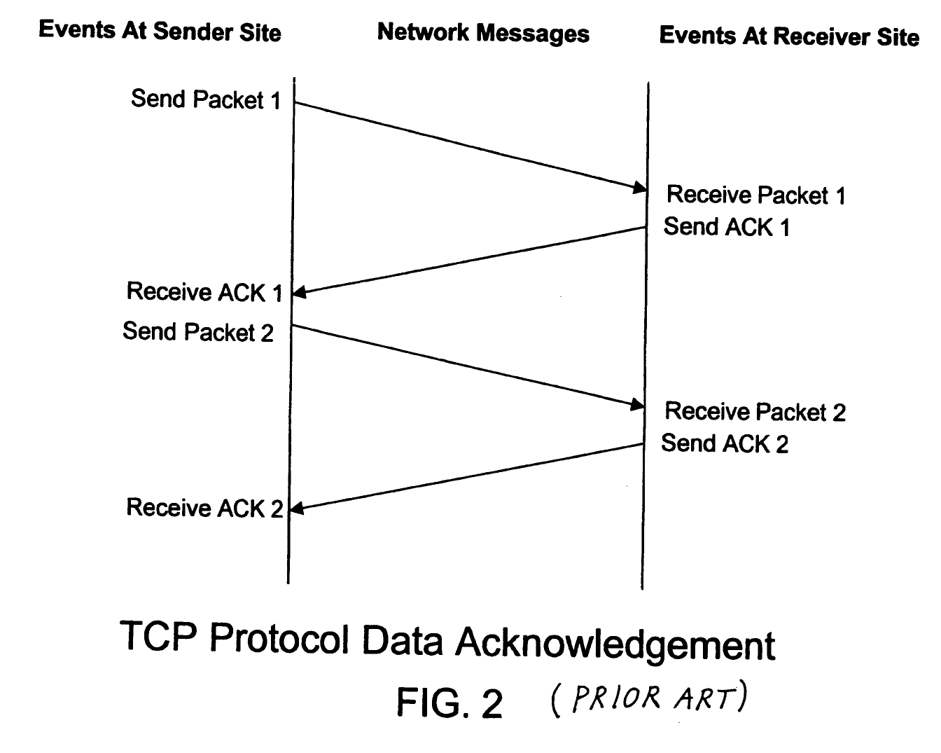

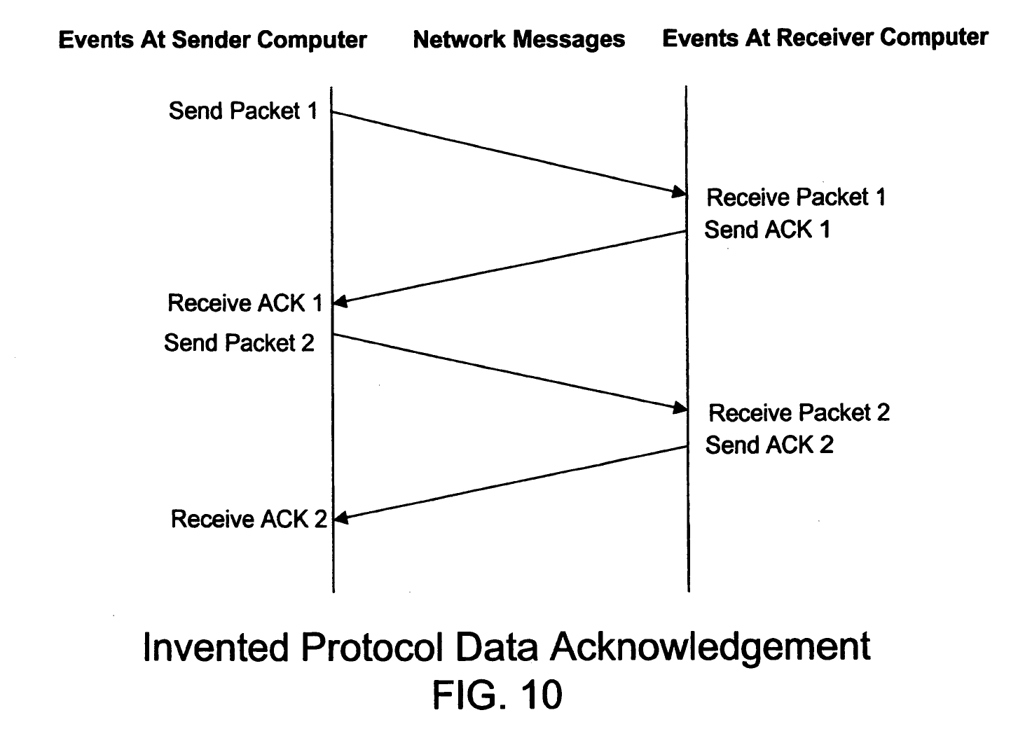

FIG. 10 depicts the network messages passing directly between the Sender Computer 1150 and the Receiver Computer 1170 following the connection setup depicted in FIG. 9. The data acknowledgment protocol depicted in FIG. 10 is identical to that of the standard TCP data acknowledgement protocol depicted in FIG. 2, and as such is passed without effect through both the Sender Firewall and NAT Router 1160 and the Receiver Firewall and NAT Router 1180.

FIG. 11 depicts network topology for establishing a direct connection between two computers behind firewalls.

FIG. 9 messages and events and FIG. 10 messages may be grouped into four general tasks.

First, the Sender Computer 1150 establishes an outgoing connection to the Non-firewalled Computer 1190. This connection is used for indirectly messaging between the Sender Computer 1150 and the Receiver Computer 1170 prior to establishing a direct connection.

The first function following START on FIG. 7 registers the Firewalled Computer by opening an outbound connection to the Non-firewalled Computer 1190 and sending its IP and port number to the Non-firewalled Computer 1190. Both the potential Sender Computer 1150 and the Receiver Computer 1170 registers its IP and port with the Non-firewalled Computer 1190.

The second function following START on FIG. 7 continuously listens for a “make connection” message on the TCP channel. When the “make connection” message is received from the Non-firewalled Computer 1190 the function starts the Firewalled Computer state machine on the Receiver Computer 1170. The “make connection” message is sent by the Non-firewalled Computer 1190 in response to a send request issued from the Sender Computer 1150 to the Non-firewalled Computer 1190.

Second, an outbound TCP connection between the Receiver Computer 1170 and the Sender Computer 1150 is created by the Receiver Computer 1170 and the Non-firewalled Computer 1190. The task is initiated in response to the Sender Computer's 1150 request for connection to the Receiver Computer 1170 transmitted to the Non-firewalled Computer 1190. The connection to the Receiver Computer 1170 appears to the Receiver Firewall and NAT Router 1160 to be a permitted outbound TCP connection initiated by the Receiver Computer 1170. The IP and port necessary to directly communicate with the Receiver Computer 1170 is made known to the Non-firewalled Computer 1190.

The first line of FIG. 9 shows the Sender Computer 1150 establishing an outbound TCP connection to the Non-firewalled Computer 1190. Even a Sender Firewall and NAT Router 1160 that blocks all inbound connections and translates all ports and IP addresses will allow an outbound connection to a Non-firewalled Computer 1190. The connection is similar to that for requesting a Web page. The Sender Computer 1150 requests that the Non-firewalled Computer 1190 connect it to a Receiver Computer 1170 that has previously registered its IP and port with the Non-firewalled Computer 1190.

Sender Computer 1150 state 0 (see FIG. 7) provides the Non-firewalled Computer 1190 with the Sender Computer 1150's port after translation by the Sender NAT Router 1160.

Non-firewalled Computer 1150 state 3 (see FIG. 8) sends a message on the TCP channel opened in the START step above and directs the Receiver Computer 1170 to make a connection to the Sender Computer 1150's IP and port.

Receiver Computer 1170 state 0 (see FIG. 7) provides the Non-firewalled Computer 1190 with the Receiver Computer 1170's port after translation by the Receiver NAT Router 1180.

Upon prompting by the Non-firewalled Computer 1190, Receiver Computer 1170 state 2 (see FIG. 7) sends a blizzard of short Time to Live (TTL) SYN packets to the Sender Computer 1150. The blizzard is a plurality of SYN packets with different destination ports based on the port received by the Non-firewalled Computer 1190 state 2 (see FIG. 8). In a preferred embodiment, the different destination ports are “guessed” by incrementing the Sender Computer's port number provided by the Non-firewalled Computer. Alternative methods for determining the different destination port addresses include random selection or a predetermined selection process or algorithm. The purpose of the blizzard is to open a series of firewall holes from the Receiver Computer 1170 to the Sender Computer 1150. The SYNs are sent with short TTLs so that they will open holes in the Receiver Firewall and NAT Router 1180 but not reach the Sender Firewall and NAT Router 1160 and thereby generate a TCP RESET signal. Upon completion of sending the blizzard of SYN packets, Receiver Computer 1170 state 3 (see FIG. 7) sends a “SYN blizzard sent” message to the Non-firewalled Computer 1190.

When the Receiver Computer 1170 has finished sending its SYN blizzard and the Non-firewalled Computer has received the “SYN blizzard sent” message from the Receiver Computer 1170, the Non-firewalled Computer 1190 state 7 (see FIG. 8) sends a SYNACK blizzard to the Receiver Computer 1170 consisting of packets with their source IP and port set to the IP and port of the Sender Computer 1150.

The Receiver Computer 1170 state 5 (see FIG. 7) sends the port that penetrated the Receiver Firewall and NAT Router 1180 to the Non-firewalled Computer 1190.

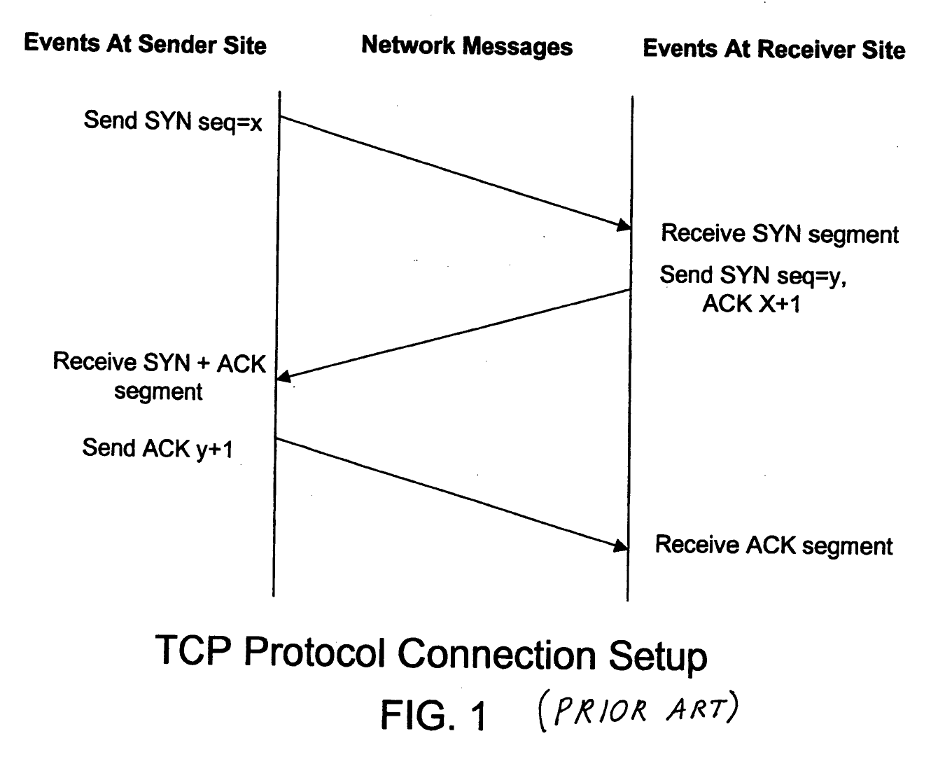

The Receiver Computer 1170 state 6 (see FIG. 7) sends an ACK packet to the Sender Computer 1150 with a short TTL. From the perspective of the Receiver Firewall and NAT Router 1180, the ACK completes the three-way handshake necessary to establish a TCP connection as described in FIG. 1. The short TTL allows the ACK to traverse the Receiver Firewall and NAT Router 1180 to complete the handshake but prevents the ACK from reaching the Sender Firewall and NAT Router 1160 thereby generating a TCP RESET signal.

The TCP three-way handshake consisting of SYN, SYNACK, and ACK is depicted in FIG. 1. The corresponding signals have now been generated in the Receiver Computer 1150 state machine by Receiver(2) SYN, Receiver(4) SYNACK, and Receiver(6) ACK.

By Non-firewalled Computer 1190 state 9 (see FIG. 8), the Non-firewalled Computer 1190 knows that the Receiver Firewall and NAT Router has been opened and knows the IP and port address necessary to directly communicate with the Receiver Computer 1170.

Third, an outbound TCP connection between the Sender Computer 1150 and the Receiver Computer 1170 is created by the Sender Computer 1150 and the Non-firewalled Computer 1190. The connection between the Sender Computer 1150 and the Receiver Computer 1170 appears to the Sender Firewall and NAT Router 1160 to be a permitted outgoing connection initiated by the Sender Computer 1150.

Upon prompting by the Non-firewalled Computer 1190, Sender Computer 1150 state 2 (see FIG. 7) sends a blizzard of short Time to Live (TTL) SYN packets to the Receiver Computer 1170. The blizzard is a plurality of SYN packets with different destination ports based on the port received by the Non-firewalled Computer 1190 state 4 (see FIG. 8). The purpose of the blizzard is to open a series of firewall holes from the Sender Computer 1150 to the Receiver Computer 1170. The SYNs are sent with short TTLs so that they will open holes in the Sender Firewall and NAT Router 1180 but not reach the Receiver Firewall and NAT Router 1180 and thereby generate a TCP RESET signal. Upon completion of sending the blizzard of SYN packets, Sender Computer 1150 state 3 (see FIG. 7) sends a “SYN blizzard sent” message to the Non-firewalled Computer 1190.

When the Sender Computer 1150 has finished sending its SYN blizzard and the Non-firewalled Computer 1190 has received the “SYN blizzard sent” message from Sender Computer 1150, the Non-firewalled Computer 1190 state 11 (see FIG. 8) sends a SYNACK blizzard to the Sender Computer 1150 consisting of packets with their source IP and port set to the IP and port of the Receiver Computer 1170.

The Sender Computer 1150 state 5 (see FIG. 7) sends the port that penetrated the Sender Firewall and NAT Router 1160 to the Non-firewalled Computer 1190.

The Sender Computer 1150 state 6 (see FIG. 7) sends an ACK packet to the Receiver Computer 1170 with a short TTL. From the perspective of the Sender Firewall and NAT Router 1180, the ACK completes the three-way handshake necessary to establish a TCP connection as described in FIG. 1. The short TTL allows the ACK to traverse the Sender Firewall and NAT Router 1180 to complete the handshake but prevents the ACK from reaching the Receiver Firewall and NAT Router 1180 thereby generating a TCP RESET signal.

The TCP three-way handshake consisting of SYN, SYNACK, and ACK is depicted in FIG. 1. The corresponding signals have now been generated in the Sender Computer 1150 state machine by Sender(2) SYN, Sender(4) SYNACK, and Sender(6) ACK.

By Non-firewalled Computer 1190 state 13 (see FIG. 8), the Non-firewalled Computer 1190 knows that the Receiver Firewall and NAT Router 1180 has been opened and knows the IP and port address necessary to directly communicate with the Receiver Computer 1170. It furthermore knows that the Sender Firewall and NAT Router 1160 has been opened and knows the IP and port address necessary to directly communicate with the Sender Computer 1150.

Non-firewalled Computer 1190 states 13 and 14 (see FIG. 8) send messages using the TCP channel confirming that a direct connection has been established between the two Firewalled Computers 1150 1170.

Fourth, data may be sent and acknowledged over the direct connection between the two Firewalled Computers 1150 1170. FIG. 10 illustrates the sending and acknowledgment of data directly between the Sender Computer 1150 and the Receiver Computer 1170. From the point of view of the Sender Firewall and NAT Router 1160 and the Receiver Firewall and NAT Router 1180, the sent data PSHACKs and corresponding ACKs are outbound traffic associated with open TCP connections as depicted in FIG. 2. Unlike a proxy configuration, once the direct connection between the two Firewalled Computers is established, the Non-firewalled Computer 1190 does not participate in the data transfer between the two Firewalled Computers 1150 1170.

Embodiments of the present invention comprise computer components and computer-implemented steps that will be apparent to those skilled in the art. Furthermore, is should be understood that computer-implemented steps are preferably stored as computer-executable instructions on a computer-readable medium such as, for example, floppy disks, hard disks, optical disks, Flash memories, Flash ROMS, nonvolatile ROM, and RAM. For ease of exposition, not every step or element of the present invention is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the present invention.

Having thus described at least illustrative embodiments of the invention, various modifications and improvements will readily occur to those skilled in the art and are intended to be within the scope of the invention. Accordingly, the foregoing description is by way of example only and is not intended as limiting.

What is claimed:

1. A method for connecting a first computer protected by a first firewall to a second computer protected by a second firewall using a trusted computer, the method comprising:
registering the first computer with the trusted computer;
receiving a connection request from the trusted computer, the connection request including an IP address and port number of the second computer;
opening a plurality of ports through the first firewall;
receiving an acknowledgement from the trusted computer on a penetration port, the penetration port being one of the plurality of opened ports;
sending the trusted computer the port number of the penetration port; and
receiving data directly from the second computer on the penetration port.

2. The method of claim 1 wherein the first firewall is configured to block inbound connections to a port on the first computer.

3. The method of claim 2 wherein the first firewall is configured to block all inbound connections to the first computer.

4. The method of claim 1 wherein the step of registering further comprises sending the trusted computer an IP address and port number of the first computer.

5. The method of claim 1 wherein the step of opening further comprises:
receiving a generated port number of the second computer from the trusted computer;
sending a plurality of messages to the second computer's IP address and generated port, each of the plurality of messages opening a port on the first computer.

6. The method of claim 5 further comprises sending a message to the trusted computer confirming that the plurality of messages has been sent.

7. The method of claim 5 wherein each of the plurality of messages have a short TTL.

8. The method of claim 1 wherein the acknowledgement from the trusted computer is modified to indicate the second computer's IP address and the penetration port as the origin of the acknowledgement.

9. A method for assisting a first computer protected by a first firewall to connect to a second computer protected by a second firewall, the method comprising:
receiving from the first computer a request to connect to the second computer;
sending a connection request to the second computer;
maintaining a hole through the second firewall created by the second computer;
receiving a destination port number from the second computer, the receiving port number corresponding to the punched hole in the second firewall;
maintaining a hole through the first firewall created by the first computer;
receiving a origination port number from the first computer, the origination port number corresponding to the punched hole in the first firewall;
sending a message to the second computer confirming a direct connection between the first and second computers.

10. The method of claim 9 wherein the second firewall is configured to block inbound connections to a port on the second computer.

11. The method of claim 10 wherein the second firewall is configured to block all inbound connections to the second computer.

12. The method of claim 9 wherein the first firewall is configured to block inbound connections to a port on the first computer.

13. The method of claim 9 wherein the connection request sent to the second computer comprises an IP address of the first computer.

14. The method of claim 9 wherein the step of maintaining a hole through the second firewall further comprises:
instructing the second computer to open a plurality of ports through the second firewall, the plurality of ports using generated port addresses;
receiving from the second computer a message indicating that the plurality of ports through the second firewall have been opened; and
sending a plurality of messages to the second computer, each of the plurality of messages having a different port number, the different port numbers based on the generated port addresses.

15. The method of claim 9 wherein the step of maintaining a hole through the first firewall further comprises:
instructing the first computer to open a plurality of ports through the first firewall;
receiving from the first computer a message indicating that the plurality of ports through the first firewall have been opened; and
sending a plurality of messages to the first computer, each of the plurality of messages having a different port number.

16. The method of claim 14 wherein each of the plurality of messages sent to the second computer is modified to indicate the originator of the messages is the first computer.

17. The method of claim 15 wherein each of the plurality of messages sent to the first computer is modified to indicate the originator of the messages is the second computer.

18. A computer-readable medium having computer-executable instructions for performing a method for assisting a first computer protected by a first firewall to connect to a second computer protected by a second firewall, the method comprising:
receiving from the first computer a request to connect to the second computer;
sending a connection request to the second computer;
maintaining a hole through the second firewall created by the second computer;
receiving a destination port number from the second computer, the receiving port number corresponding to the punched hole in the second firewall;
maintaining a hole through the first firewall created by the first computer;
receiving a origination port number from the first computer, the origination port number corresponding to the punched hole in the first firewall;
sending a message to the second computer confirming a direct connection between the first and second computers.
